(19) United States
(12) Patent Application Publication
(10) Pub. No.: US 2012/0078450 A1
(43) Pub. Date: Mar. 29, 2012

(54) DISPLAY INFORMATION TO SUPPORT CLIMB OPTIMIZATION DURING CRUISE

(75) Inventors: Stephane Marche, Toulouse (FR); Petr Krupansky, Veverska Bityska (CZ); Tomas Neuzil, Brno (CZ); George Papageorgiou, Toulouse (FR); Jean-Luc Derouineau, Toulouse (FR)

(73) Assignee: HONEYWELL INTERNATIONAL INC., Morristown, NJ (US)

(21) Appl. No.: 12/891,581

(22) Filed: Sep. 27, 2010

(51) Int. Cl. G05D 1/06

(52) U.S. Cl. 701/6; 701/5

(57) ABSTRACT

Methods and systems are provided for executing a single continuous altitude change by an aircraft to cruise altitude using an electronic flight bag via a flight management system. The method comprises the determination of an altitude change in a flight plan during the cruise phase of the flight plan. Based on the altitude change and a mathematical model of the aircraft an optimum vertical trajectory profile or the aircraft is determined from which an angle of attack (AOA) and a thrust is derived to achieve the optimum vertical trajectory. From the AOA and the thrust, the required aircraft control variables are determined that may be applied to the engines and the control surface actuators of the aircraft.

### TECHNICAL FIELD

The present invention generally relates to aircraft computer systems, and more particularly relates to computer system functionality for optimizing vertical profile advisories to a pilot during the cruise climb phase of a flight plan.

### BACKGROUND

FIG. 1 is an illustration of an exemplary flight plan. Today, according to air traffic control (ATC) protocol, aircraft are required to climb to altitude from the top-of climb (TOC) to the top-of-descent (TOD) during their cruise phase in incremental climbs of 1000 or 2000 feet, regardless of fuel or environmental efficiency. Conventional Flight Management Systems (FMS) are currently configured to take this incremental climb limitation into account and thus automatically restrict a pilot's flexibility to operate his aircraft in the most efficient manner, which may be a single continuous climb.

Currently, ATC authorities are investigating the relaxation of incremental climb protocols in the interest of fuel economy and the minimization of environmental impact, which are directly related. Continuous climb authorization will enable aircraft to fly an optimum trajectory using optimum angles-of-attack (AOA) that may change from time to time during the cruise phase of the flight plan. An AOA is the angle at which a relative wind meets an airfoil, which is the aircraft wing. It is the angle that is formed by the chord of the airfoil and the direction of the relative wind or, in other words, between the chord line of the airfoil and the flight path. The optimal AOA changes during a flight as the pilot changes the direction of the aircraft or the relative wind changes. The AOA is one of the factors that determine the aircraft's rate of speed through the air.

However, the cost and time required to redesign the currently installed inventory of FMS's to accommodate a continuous cruise climb protocol is significant. Accordingly, it is desirable to devise systems and methods to allow continuous climb without the need to modify the currently installed base of FMSs. In addition, it is desirable to alert a pilot when a continuous climb/descent would be beneficial. Furthermore, other desirable features and characteristics of the present invention will become apparent from the subsequent detailed description of the invention and the appended claims, taken in conjunction with the accompanying drawings and this background of the invention.

### BRIEF SUMMARY

A method is provided for executing a single continuous altitude change by an aircraft to a cruise altitude. The method comprises the steps of determining an altitude change in a flight plan to be executed during the cruise phase of the flight plan and determining an optimum vertical trajectory profile of the aircraft based at least in part on a mathematical model of the aircraft and the altitude change. The method then proceeds by determining an angle-of-attack (AOA) and a thrust based at least in part on the optimum vertical trajectory profile that reaches the cruise altitude in a single continuous altitude change. Once the AOA and the corresponding thrust is determined, aircraft control variables that are necessary to achieve the AOA and the thrust are generated and applied to one or more aircraft controls to effectuate a single continuous altitude change to the cruise altitude.

A system is provided for executing a single continuous altitude change by an aircraft to a cruise altitude. The system comprises a mathematical model of the aircraft. The system also comprises a first module configured to compute an optimal vertical profile based in part on the mathematical model and a second module configured to generate one or more aircraft control variables based at least in part on the optimal vertical profile, wherein the one or more aircraft control variables drives one of an aircraft control surface and an aircraft engine.

A system is provided for executing a single continuous altitude change by an aircraft to a cruise altitude. The system comprises a mathematical model of the aircraft. The system also comprises a first means for computing an optimal vertical profile based in part on the mathematical model; a second means for generating one or more aircraft control variables based at least in part on the optimal vertical profile; and a third means for driving one of an aircraft control surface and an aircraft engine based at least in part on the one or more aircraft control variables.

### BRIEF DESCRIPTION OF THE DRAWINGS

The present invention will hereinafter be described in conjunction with the following drawing figures, wherein like numerals denote like elements, and

FIG. 1 is a graph of an exemplary flight plan trajectory;

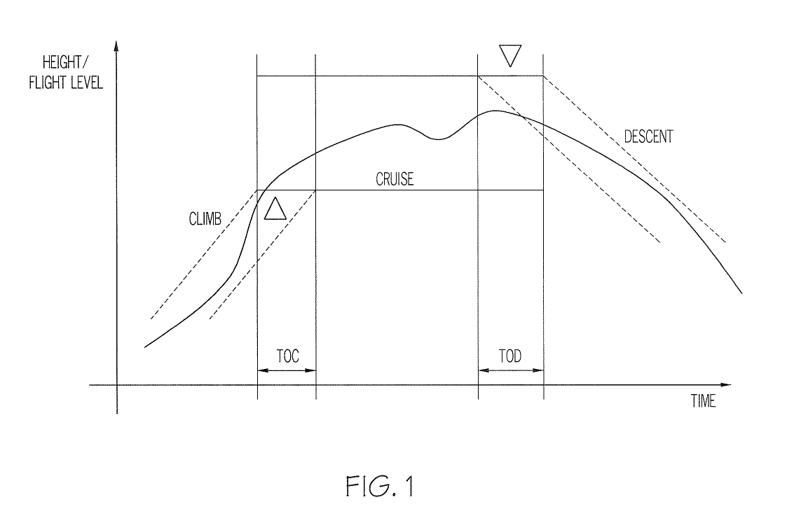

FIG. 2 is a view of a generic aircraft cockpit;

FIG. 3 is a view of an exemplary embodiment utilizing a generic cockpit display unit (CDU);

FIG. 4 is a view of an exemplary embodiment utilizing an electronic flight bag (EFB) system display.

FIG. 5 is a simplified functional block diagram of a CDU and/or an EFB in communication with a Flight Management System;

FIG. 6 is a flow chart of an exemplary embodiment for manually executing an optimal continuous altitude change by an aircraft to cruise altitude using an aircrew advisory; and

FIG. 7 is a flow chart of an exemplary embodiment automatically executing an optimal single continuous altitude change by an aircraft to cruise altitude.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

The subject matter now will be described more fully below with reference to the attached drawings which are illustrative of various embodiments disclosed herein. Like numbers refer to like objects throughout the following disclosure. The attached drawings have been simplified to clarify the understanding of the systems, devices and methods disclosed. The subject matter may be embodied in a variety of forms. The exemplary configurations and descriptions, infra, are provided to more fully convey the subject matter disclosed herein. The subject matter will be disclosed below in the context of an aircraft. However, it will be understood by those of ordinary skill in the art that the subject matter is similarly applicable to other vehicle types.

The exemplary embodiments disclosed herein are solutions that may be implemented by modifying a Flight Management System (FMS) or with an Electronic Flight Bag (EFB) without modifying the FMS. These solutions enable fuel consumption optimization by flying a continuous climb trajectory while continuously adjusting certain aircraft control parameters in real time during the cruise phase of a flight plan. Although the term “continuous climb” as used herein implies an increase in altitude, in equivalent embodiments local variations in atmospheric conditions could indicate that a temporary descent during the cruise phase climb may be warranted. As such, aircraft control parameters discussed herein also may apply to aircraft descents during an overall cruise phase climb.

An EFB is an electronic information management device/system that helps a flight crew to perform flight management tasks more easily and efficiently with less paper. It is a general purpose computing platform intended to reduce, or replace, paper-based reference material often found in the Pilot's carry-on flight bag, including the Aircraft Operating Manual, Flight Crew Operating Manual, and Navigational Charts (including moving map for air and ground operations). In addition, the EFB can host purpose-built software applications to automate other functions normally conducted by hand, such as a continuous climb functionality.

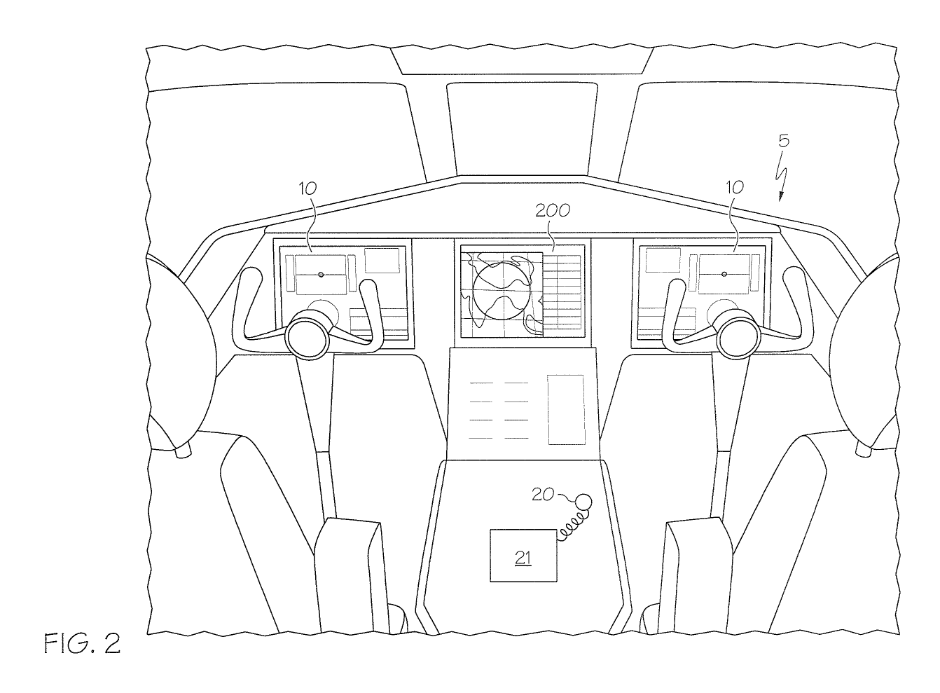

FIG. 2 is an exemplary view of an aircraft cockpit that includes an FMS 5 that may communicate with, or may incorporate within itself, a Cockpit Display Unit (CDU) 200. Generally, the FMS 5 may comprise one or more primary flight displays 10 that display information. The equipment arrangement of FIG. 2 is merely exemplary. In equivalent embodiments the equipment and the equipment arrangement will vary considerably from airframe to airframe without reducing the applicability of the subject matter described herein below. The cockpit may also include an interface 20 to receive input from an externally connected EFB 21. However, in equivalent embodiments all or some portion of the hardware, firmware and/or software of the EFB 21 may be incorporated into the FMS 5 or other cockpit system.

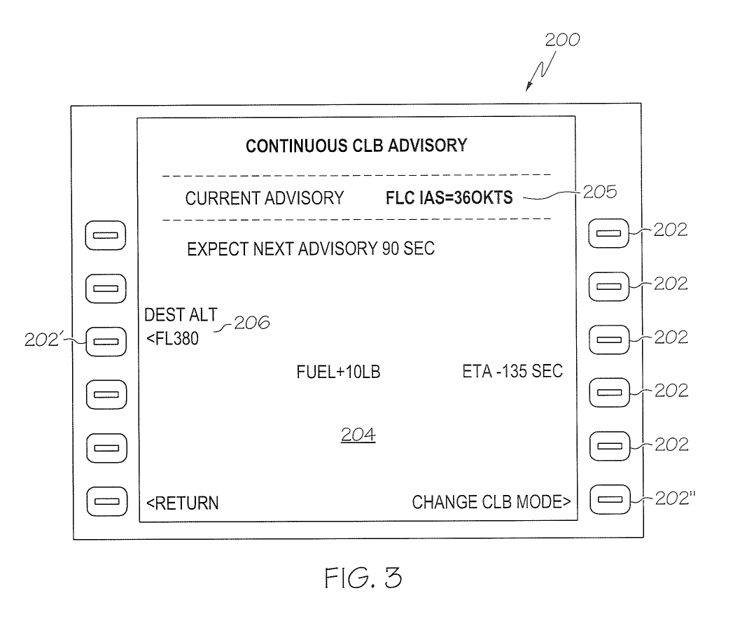

FIG. 3 is a simplified rendition of a non-limiting, exemplary CDU 200 displaying a continuous climb advisory 205/206. In one embodiment, CDU 200 may comprise a physical display device with multiple physical input transducers 202 and one or more physical display screens 204 for interfacing with the flight crew. Some exemplary, non-limiting transducers 202 may include push buttons, switches, knobs, touch pads and the like. Exemplary, non-limiting displays 204 may include light emitting diode arrays, liquid crystal displays, cathode ray tubes, incandescent lamps, etc.

In other embodiments, the CDU 200 may be a virtual device. The display 204 for the virtual device may be rendered on a general purpose electronic display device where the transducers 202 are electronic, graphical renditions of a physical device. Such electronic display devices may be any type of display device known in the art. Non-limiting examples of a display device may be a cathode ray tube, a liquid crystal display and a plasma screen. However, any suitable display device developed now or in the future is contemplated to be within the scope of this disclosure. Regardless of the nature of the CDU 200, any suggested aircraft maneuvers may be displayed in a display 204, such as the information 205.

The exemplary continuous climb advisory 205/206 is suggesting to the pilot that a climb to flight level 380 at a speed of 360 knots is most efficient. The advisory indicates to the pilot that the climb will save 10 pounds of fuel and take 135 seconds off the flight time. Manipulating the transducer 202′ by the pilot accepts the suggested altitude change and causes the FMS 5 and the autopilot (if any) to execute the necessary flight control commands to achieve the altitude change in a single continuous climb. Transducer 202″ allows the pilot to select between any climbing modes that may be proposed to the pilot. Some exemplary, non-limiting climb modes may include a Flight Level Change/Indicated Air Speed (“FLC/IAS”) mode, a Vertical Speed Mode (“VSM”) and an Altitude Change Mode (“ACM”) as may be known in the art. The FLC/IAS mode holds the speed of climb constant while climbing to the new flight level limit. The VSM mode puts the aircraft into a constant speed climb with out a specific limit. The ACM mode sets the new altitude and allows the aircraft to set the vertical speed to reach the new flight level. In addition, there may be an Automatic Mode, whereby the climbing mode may be selected automatically by the aircraft based on the real time atmospherics limited but by the flight plan and ATC clearance limitations. In some embodiments the pilot may manually execute any or all of the flight control commands to achieve the suggested altitude change.

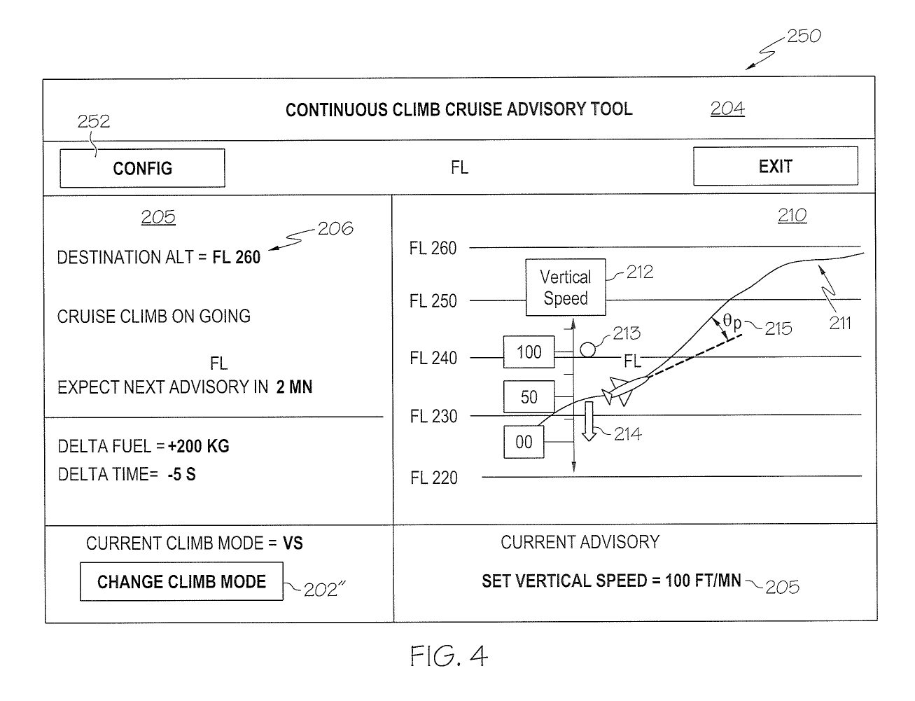

FIG. 4 is a simplified rendition of a non-limiting, exemplary EFB display 250 that has analogous continuous climb advisory functionality to that of the CDU display 204 of FIG. 3. EFB display 250 may comprise one of more electronic or virtual transducers 202. The exemplary display of FIG. 4 is informing the pilot that he is already in a continuous climb to flight level 260 and that the next climb advisory will be generated in 2 minutes. Fuel and time savings resulting from the climb are calculated to be 200 kilograms of fuel and five seconds. The symbology used in FIG. 4 is merely exemplary. Other symbologies may be employed without departing from the scope of the subject matter being disclosed herein.

The exemplary EFB display 250 may also incorporate a graphical display of the continuous ascent profile 210. The ascent profile 210 may include the exemplary projected climb trajectory 211, the exemplary current aircraft pitch angle 215, and an exemplary vertical speed indicator 212. The vertical speed indicator 212 may include a symbol 213 that indicates the target vertical speed of the ascent. The vertical speed indicator 212 may also include trend symbology 214, where in some embodiments the trend embodiment may be manifested as a vertical speed trend arrow. For example, the tail of the vertical speed trend arrow may indicate the current vertical speed of the aircraft and its downward direction may indicate the vertical speed is dropping.

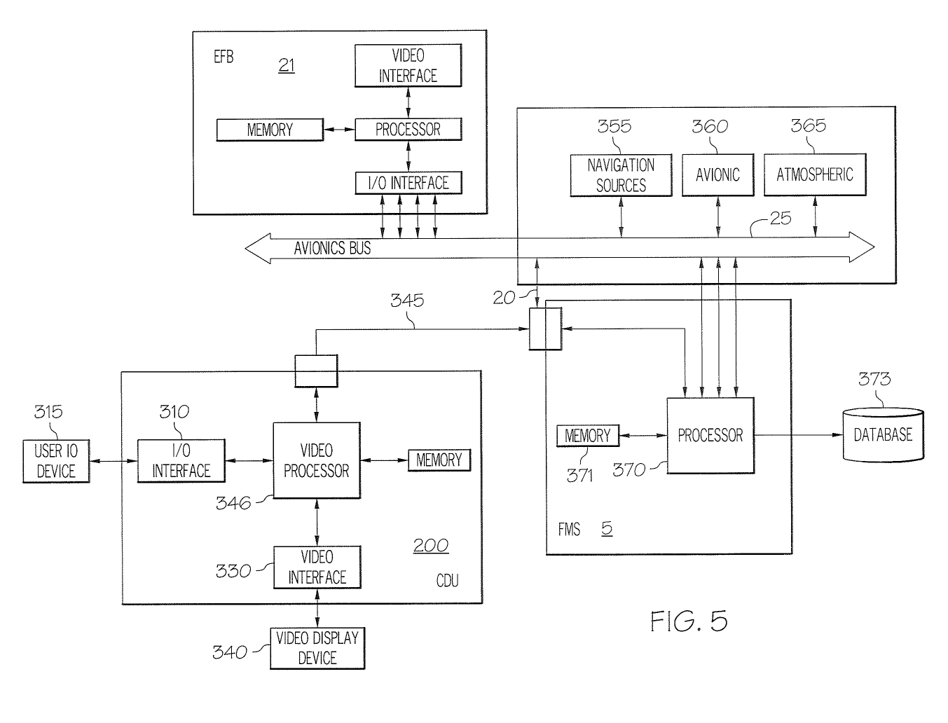

FIG. 5 depicts an exemplary system 300 that may be used to implement the subject matter described herein. Although this exemplary embodiment discloses an FMS 5 and a separate CDU 200, in equivalent embodiments the functions of the FMS 5, the EFB 21 and the CDU 200 may be combined into a single computing device, broken out into additional devices or be distributed over a wireless or a wired network.

The FMS 5 may comprise a processor 370. Processor 370 may be any suitable processor or combination of sub-processors that may be known in the art. Processor 370 may include a central processing unit, an embedded processor, a specialized processor (e.g. digital signal processor), or any other electronic element responsible for interpretation and execution of instructions, performance of calculations and/or execution of voice recognition protocols. Processor 370 may communicate with, control and/or work in concert with, other functional components such as a navigational system 355, a database 373, one or more avionic sensor/processors 360, one or more atmospheric sensor processors 365, and/or one or more data interfaces 345. The processors 370 and memory device 371 are non-limiting examples of a computer readable storage medium. A computer storage medium does not include an electronic signal.

The processor 370, as noted above, may communicate with database 373. Database 373 may be any suitable type of database known in the art. Non-limiting exemplary types of databases include flat databases, relational databases, and post-relational databases that may currently exist or be developed in the future. Database 373 may be recorded on any suitable type of non-volatile or volatile memory devices such as optical disk, programmable logic devices, read only memory, random access memory, flash memory and magnetic disks. The database 373 may store flight plan data, aircraft operating data, a mathematical model of the aircraft, navigation data and other data as may be operationally useful. The database 373 may be an additional, non-limiting example of a computer readable medium.

Processor 370 may include or communicate with a memory module 371. Memory module 371 may comprise any type or combination of read only memory, random access memory, flash memory, programmable logic devices (e.g. a programmable gate array) and/or any other suitable memory device that may currently exist or be developed in the future. The memory module 371 is a non-limiting example of a computer readable medium and may store any suitable type of information. Non-limiting examples of such information include flight plan data, flight plan change data, aircraft operating data and navigation data.

As discussed above in regard to FIG. 2, FMS 5 may also have an EFB interface 20 in operable communication between the EFB 21 (via an avionics bus 25) and the processor 370. The EFB interface 20 allows communication between the EFB 21 and the FMS 5. In some embodiments, the methods disclosed herein, or parts thereof, may be accomplished by the EFB 21 thereby eliminating the need to modify the programming or redesign the hardware of the FMS 5.

The data I/O interface 345 and EFB interface 20 may be any suitable type of wired or wireless interface as may be known in the art. The data I/O interface 345 and the EFB interface 20 transmit graphical information between CDU 200 and the processor 370 of FMS 5 or the EFB 21. Wireless interfaces, if used to implement the data I/O interface 345 or the EFB interface 20 may operate using any suitable wireless protocol. Non-limiting, exemplary wireless protocols may include Wi-Fi, Bluetooth™, and Zigbee.

The CDU 200 includes processor 346. Processor 346 may be any suitable processor or combination of sub-processors that may be known in the art. Processor 346 may include a central processing unit, an embedded processor, a specialized processor (e.g., digital signal processor), or any other electronic element responsible for the interpretation and execution of instructions, the performance of calculations and/or the execution of voice recognition protocols. Processor 346 may communicate with, control and/or work in concert with, other functional components including but not limited to a video display device 340 via an video interface 330, a user I/O device 315 via an I/O interface 310 and one or more data interfaces 345. The processor 346 is a non-limiting example of a computer readable medium. The user I/O device 315 and video display device 340 may be components within CDU 200. The display device 340 may also include the transducers 202, 202′ and 202″ as well as the visual displays 204 discussed above in regard to FIG. 3.

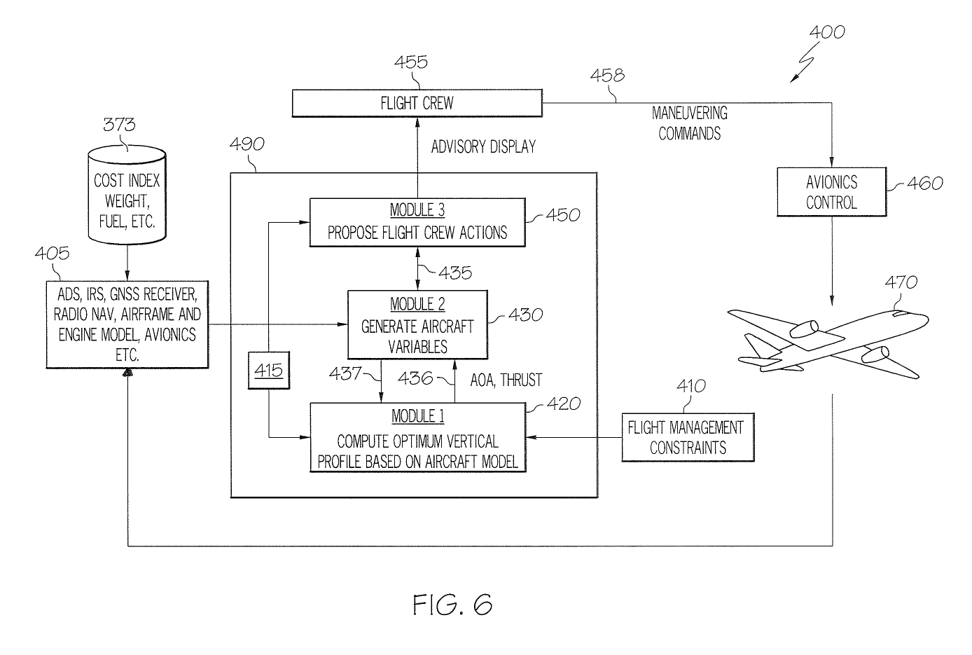

FIG. 6 is a simplified flow chart 400 of an exemplary system 400 for presenting an optimized continuous climb to cruise recommendations to a pilot and closing the system loop by pilot action. In some embodiments, the system 400 may comprise three modules. The term module as used herein describes a structural feature included in various exemplary embodiments that may comprise a software object, a hardware device, firmware or any combination thereof. Software modules execute on either general or special purpose computer processors. Although three modules are disclosed herein, in equivalent embodiments the three modules may be combined into fewer modules, may functionality may be rearranged between modules and any of the three modules may be broken down into sub-modules without departing from the scope of this disclosure.

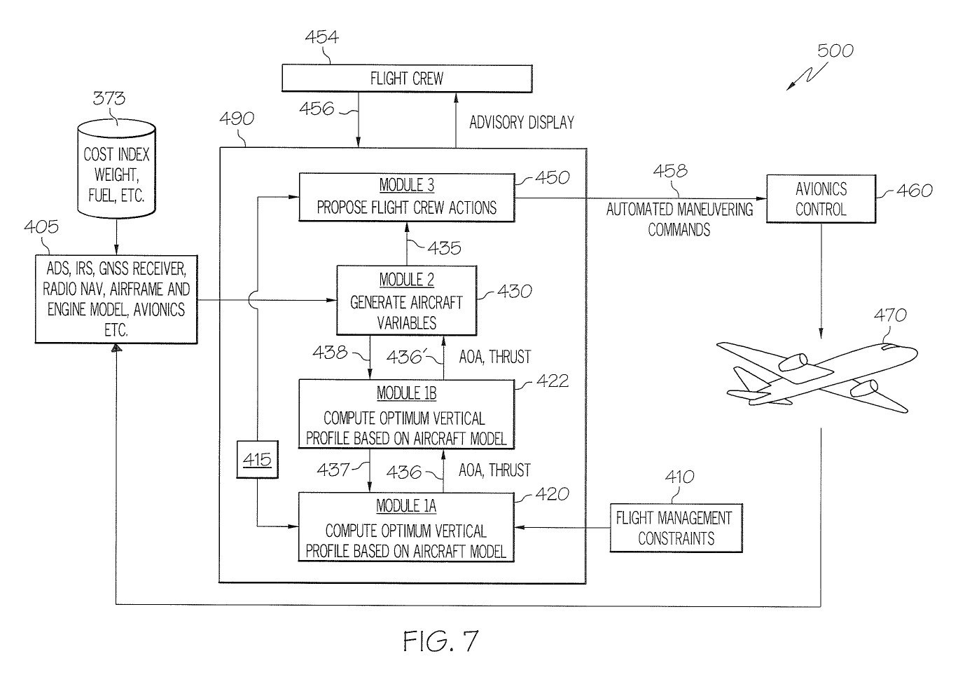

In order to address hardware and software constraints associated with a particular implementation (e.g., processor and memory constraints, Module 1 may be separated into two or more sub-modules that may be run at different update frequencies. As a non-limiting example, Module 1 may be broken up into two sub-modules, Module 1A and Module 1B (see, e.g., FIG. 7).

Module 1 may comprise, or be in operable communication with, a mathematical model 440 of the aircraft 470. Module 1 may receive flight management information 405 (e.g., a flight plan, a cost index (CI), aircraft state information, weather and/or ATC clearances) from a memory storage device 414 in the cockpit as may be appropriate.

Module 1 applies the CI, the aircraft state information and the ground information to the mathematical aircraft model 440 and outputs optimal angle-of-attack (AOA) and a thrust (T) profiles 436 that are to be implemented in order to achieve the optimal fuel efficient vertical cruise profile to reach the desired altitude.

As the aircraft 470 travels the cruise trajectory to the desired altitude, the AOA and T 436 are iteratively recalculated in real time insuring optimum aircraft performance during periods of transient atmospheric conditions (e.g. temperature, pressure, relative wind, etc.). Module 1 uses the model of the aircraft's flight mechanics and engines to minimize fuel consumption subject to time-of-arrival and ATC constraints (e.g., in trail procedures) by varying the ratio of aircraft drag (D) to lift (L) to determine the optimal AOA and by varying Thrust Specific Fuel Consumption (TSFC) to determine the optimal T. The TSFC is the mass fuel required to provide the net thrust for a given period of time. Further, due to the iterative recalculation, should atmospheric variables unexpectedly change during a level cruising trajectory, Module 1 may calculate an AOA and T for a change to a new optimum altitude.

Module 2 receives the optimal AOA and T profiles 436 and the aircraft state information (e.g. navigation, avionics and engine information) and then generates specific aircraft control variables 435 to be used by, or be presented to the pilot at process 405 for his consideration. The aircraft control variables 435 may be executed by the pilot or may be configured for execution by pin programming Pin programming indicates to the FMS 5 the aircraft type, engine type/configuration, passenger and freight weight and a plethora of other information which can then be applied to configure avionics control commands by the pre-set pin programming.

Module 2 compensates for the delay between presenting the aircraft control variables 435 to the pilot and his response. Module 2 uses modeled knowledge of the aircraft's pilot closed-loop dynamics to determine the optimal AOA and T profiles 436 using the inverse of the closed-loop aircraft dynamics in order to drive existing or future autopilot/autothrottle systems. In some embodiments, the aircraft's pilot closed-loop dynamics can be represented as the aircraft's closed-loop dynamics with inserted delay, which represents the pilot's reaction time to a proposed maneuver.

To maintain the operational stability of Module 1 and Module 2, Module 2 accounts for the configuration of Module 2 and for pilot intervention in the system. This configuration feedback 437 adjusts the frequency of any updates to the AOA and T profiles 436 in order to eliminate variable changes that are impracticable in view of the requirement for pilot review and acceptance, and supports fight stability during that review/response period.

Module 3 implements the aircraft control variables 435 at the aircraft control surfaces and the engine(s) to achieve the optimal fuel efficient vertical cruise profile that is being flown by the pilot in some embodiments or by the autopilot or autothrottle in other embodiments. If the aircraft is being flown by the pilot, implementation takes the form of explicit throttle and control surface settings being displayed on the CDU 200.

All three modules update their outputs at periodic time intervals so as to iteratively adjust to local atmospheric conditions, to account for the incremental fuel burn and adjust to variations in other aircraft mechanics. For example, the AOA and T profiles 436 generated by Module 1 could result in an intermediate descent during cruise if the flight CI is small. The CI information may be retrieved from memory storage 414. Aircraft state information may be retrieved from aircraft onboard sensors 355, 360 and/or 365 (see, FIG. 4). A small CI may indicate that fuel efficiency is more important than a time-of arrival. Thus, Module 1 would output an AOA that substantially minimizes the ratio of D to L and maximizes T in order to minimize the TSFC. As fuel is expended, the aircraft would climb. However, if the aircraft encountered warm air, revised calculations may instead cause the aircraft to descend. In equivalent embodiments vertical acceleration may be limited or damped to prevent passenger comfort or cargo safety.

At process 405, ATC flight level change clearance messages, weather advisory messages and/or CI related information are received via data message or voice radio and automatically parsed and processed. Additional background information concerning exemplary methods for the automatic receipt and processing of clearance messages is more fully disclosed in U.S. patent application Ser. No. 12/412,163 to Jiri Vasek and is hereby incorporated by reference in its entirety.

Flight information is retrieved from the database 373. Additionally, environmental information garnered from various onboard sensors 355, 360 and 365 (FIG. 3) of the aircraft 470 is determined. As non-limiting examples, environmental information may include a ground location, ambient temperature, atmospheric pressure, current speed, true wind velocity, and relative wind velocity.

At process 415, the clearance information, weather information, CI information and aircraft specific information is loaded into a computer model of the aircraft that may be resident within one or more processors 370 of the FMS 5 (FIG. 3) or Module 1. The flight management constraints 410 may also be used to compute the optimal AOA and T profile.

At process 420, an optimal AOA and T profile 436 is determined by the aircraft model 440 utilizing the clearance, weather, avionics information and flight management constraints 410 received in process 405. The optimal AOA and T profiles 436 provide specific aircraft control data that will cause the aircraft to ascend to a new altitude with the least cost in terms of prevailing winds, cargo weight, fuel burn, other time and fixed costs, and in some embodiments, environmental impact such as exhaust emissions.

At process 430, the optimal AOA and T profiles 436 determined at process 420 and avionics/environmental information are received by Module 2. Specific aircraft control variables 435 are determined at process 430 that are necessary to meet the optimal AOA and T profile 436 requirements determined in process 420. Non-limiting examples of aircraft control variables 435 may include, but are not limited to a rate of descent or rate of climb, aircraft pitch, change in speed and change in altitude.

At process 450, autopilot and/or autothrottle instructions determined from the flight control variables 435 determined at process 430 are visually rendered to the flight crew for manual approval/execution. As an example, the rendering process at 450 may display the proposed new altitude and vertical speed generated at process 430. At this point, the pilot manually approves or overrides the recommended climb proposal at process 455. If approved, the aircraft control variables 435 are sent to the aircraft control surfaces autopilot or auto throttle commands 458 for execution at process 460, thus moving the aircraft to the new altitude.

FIG. 7 is a simplified flow chart 500 of another exemplary embodiment optimizing flight control recommendations for a continuous climb. The embodiment of FIG. 7 is essentially the same as the embodiment of FIG. 6 except that Module 1 has been split into Module 1A and Module 1B. Further, at process 454 the pilot may exercise an option to activate an automatic vertical profile mode 456 within the FMS 5 by manipulating one of the transducers 202 on CDU 200 (FIG. 2) or EFB 21. In the interest of brevity, these two features have been included in the same exemplary embodiment but may be practiced separately.

When in the automatic vertical profile mode, the suggested flight crew commands 458 (now automated maneuvering commands 458) generated at process 450 are directly transmitted to the aircraft engines and control surfaces autopilot and/or autothrottle commands at process 460 that move the aircraft to the new altitude automatically without pilot effort. In equivalent embodiments appropriate safeguards may be built into the system to allow the pilot an opportunity to override any throttle or control surface commands while in the automatic vertical profile mode.

In embodiments where Module 1 is separated into Module 1A and Module 1B, Module 1A may have the same functionality as Module 1, which predicts the optimal AOA and T profiles 436 over the entire cruise phase, to the new cruise altitude. Module 1B receives the optimal AOA and T profiles 436 and modifies them within predetermined ranges in order to compensate for any deviations away from assumptions that may have been used in developing the optimal AOA and T profiles 436. This is done to stay as close as possible to the optimal fuel efficient vertical cruise profile and satisfy the Flight Management constraints 410. Deviation may be caused by unexpected weather, instantaneous fuel burn, and uncertanties/artificialites in the aircraft model 440 that deviate from assumed values. If the AOA and T profiles 436 exceed the pre-determined ranges, then module 1B will trigger a recalculation of the AOA and T profiles by Module 1A thereby creating limited AOA and T profiles 436′.

Module 2 compensates for the much shorter delay in transmitting commands to the aircrafts engines and control surfaces. Without the pilot closing the loop, Module 2 filters the optimal AOA and T profiles 436 through the inverse of the dynamics of an autopilot/auto throttle in order to anticipate the behavior of the autopilot or autothrottle.

At process 405, ATC flight level change clearance messages, weather advisory messages and/or CI related information are received via data message or voice radio and automatically parsed and processed. Additionally, environmental information garnered from various onboard sensors 355, 360 and 365 (FIG. 3) of the aircraft 470 is determined.

At process 415, the clearance information, weather information, CI information and aircraft specific information is loaded into a computer model of the aircraft that may be resident within one or more processors 370 of the FMS 5 (FIG. 3) or Module 1. The flight management constraints 410 may also be loaded into the aircraft model 440 to prepare the optimal AOA and T profiles.

At process 420 an optimal AOA and T profile 436 is determined by the aircraft model 440 utilizing the clearance, weather, avionics information and flight management constraints 410 received in process 405. The optimal AOA and T profiles 436 provide specific aircraft control data that will cause the aircraft to ascend to a new altitude with the least cost in terms of prevailing winds, cargo weight, fuel burn, other time and fixed costs, and in some embodiments, environmental impact such as exhaust emissions.

At process 422, if the optimal AOA and T profiles 436 exceed pre-defined limits as applied at process 422 then Module 1 is triggered to recalculate optimal AOA and T profiles 436 with updated information.

At process 430, the optimal AOA and T profiles 436 determined at process 420 and avionics/environmental information are received by Module 2. Specific aircraft control variables 435 are determined at process 430 that are necessary to meet the optimal AOA and T profile 436 requirements determined in process 420. Non-limiting examples of aircraft control variables 435 may include, but are not limited to a rate of descent or rate of climb, aircraft pitch, change in speed and change in altitude.

At process 450, the altitude and climb rate instructions determined from the flight control variables 435 determined at process 430 are visually rendered to the flight crew. In practice, the rendering process at 450 displays the proposed new altitude and vertical speed generated at process 430. At this point, the pilot manually approves or overrides the recommended climb proposal at process 456. If approved, the aircraft control variables 435 are sent to the aircraft control surfaces as automated flight commands 458 for execution at process 460, thus moving the aircraft to the new altitude.

Further, the iterative nature of the calculations of the AOA and T profiles 436 by Modules 1-3 may be utilized during straight and level periods of the cruise trajectory to alert the pilot to a beneficial opportunity to change altitude. For example, if relative wind direction unexpectedly changes, the information 205 rendered by CDU 200/display device 340 may serve as a notice to the pilot that a change in altitude would be beneficial.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for executing a single continuous altitude change by an aircraft to a cruise altitude, comprising:
determining an optimum vertical trajectory profile of the aircraft based at least in part on a mathematical model of the aircraft and the altitude change;
generating aircraft control variables necessary in real time to execute the optimum vertical trajectory;
applying the control variables to one or more aircraft components to effectuate the single continuous altitude change to the cruise altitude by the aircraft; and;
repeating the generating and applying steps.

2. The method of claim 1, further comprising determining an angle-of-attack (AOA) and a thrust based at least in part on the vertical trajectory profile that will create sufficient lift to move the aircraft to the cruise altitude in a single continuous altitude change.

3. The method of claim 2, wherein the repeating the generating and applying steps also includes a step of determining the AOA and thrust based at least in part on the vertical trajectory profile that will create sufficient lift to move the aircraft to the cruise altitude in a single continuous altitude change.

4. The method of claim 2, wherein an aircraft pilot applies the control variables.

5. The method of claim 2, wherein the aircraft components are one of an engine and an air control surface.

6. The method of claim 5, wherein an electronic flight bag module applies the control variables.

7. The method of claim 5, wherein a flight management system (FMS) applies the control variables.

8. The method of claim 1, wherein the control variables comprise a rate of ascent and a change in speed.

9. The method of claim 1, wherein the repeating of the generating and applying steps is done iteratively and in real time.

10. A system for executing a single continuous altitude change by an aircraft to a cruise altitude, comprising:
a memory device containing a mathematical model of the aircraft stored thereon;
a first module configured to compute an optimal vertical profile based in part on the mathematical model and atmospheric conditions, iteratively and in real time; and
a second module configured to generate one or more aircraft control variables based at least in part on the optimal vertical profile iteratively and in real time, wherein the one or more aircraft control variables drives one of an aircraft control surface and an aircraft engine.

11. The system of claim 10, wherein the optimal vertical profile comprises an optimal angle of attack (AOA) and an optimal thrust.

12. The system of claim 11, further comprising a third module configured to interface the one or more aircraft flight control variables to the one of an aircraft control surface and an aircraft engine.

13. The system of claim 12, wherein the third module translates the one or more flight control variables into graphical flight control actions for visual display to a pilot.

14. The subsystem of claim 13, wherein the third module is resident in an electronic flight bag.

15. The system of claim 13, wherein the flight control actions are communicated to the pilot audibly.

16. The system of claim 10, wherein the first module is configured to optimize the vertical profile by varying a ratio of aircraft drag to lift.

17. The system of claim 15, wherein the first module is configured to optimize the vertical profile by varying a thrust specific fuel consumption in determining thrust.

18. The system of claim 10, wherein the pilot applies the control variables.

19. The system of claim 17, the second modules determines the optimal AOA and T using the inverse of the closed loop aircraft dynamics.

20. A system for executing an single continuous altitude change by an aircraft to a cruise altitude, comprising:
a mathematical model of the aircraft;
a first means for computing an optimal vertical profile based in part on the mathematical model;
a second means for generating one or more aircraft control variables based at least in part on the optimal vertical profile; and
a third means for driving one of an aircraft control surface and an aircraft engine; based at least in part on the one or more aircraft control variables.
